(19) United States
(12) Patent Application Publication
(10) Pub. No.: US 2021/0222493 A1
(43) Pub. Date: Jul. 22, 2021

(54) Ladder Attached Pulley Hoist and Tool Retainer System

(71) Applicant: Jhonatan Tarifa, Gaithersburg, MD (US)

(72) Inventor: Jhonatan Tarifa, Gaithersburg, MD (US)

(21) Appl. No.: 16/746,870

(22) Filed: Jan. 18, 2020

(51) Int. Cl. E06C 7/12; E06C 7/14

(52) U.S. Cl. CPC E06C 7/12; E06C 7/143

(57) ABSTRACT

A ladder pulley hoist and tool retainer system includes a shaft end configured to be received into an opening defined by a hollow rung in a side of an extension ladder and a second end configured with at least one pulley sheave, a length of the shaft being less than or greater than a width of the rungs of the ladder. The system also includes a pulley cord of a length configured to run once around the at least one pulley sheave and bear a load between a pull portion and a load portion. A tool retainer bucket and rack attaches to the shaft. A holder insert is received between the opening defined by a hollow rung in a side of an extension ladder and the shaft, the holder adapted to receive a shaft from both a left side and a right side of the ladder.

### BACKGROUND OF THE INVENTION

### Field of Invention

The present invention relates to hollow rung extension ladders, ropes and pulleys.

### Description of Related Art

The Fixed pulley is used for changing the direction of the input force. Fixed pulleys are used for flagpoles or with a hoisting device and is therefore is usually attached to a stationary object above the load. When the rope is pulled downward, the effect is that the load is lifted upwards. This type of pulley will not reduce the effort needed to lift the load, but applies the force of gravity and your weight in your favor. The mechanical advantage is 1 to 1. Therefore, to lift the load a foot, one needs to pull a foot of rope downward.

The movable pulley is used to reduce the amount of input force to lift a load. The most popular system that uses this pulley would be a well. Unlike the fixed pulley, the movable pulley is attached to the load and is lifted by pulling up on the rope, making it twice as easier to lift a heavy object. In this case, a 20 pound load could be lifted with just 10 pounds of input force. The tradeoff is that one has to pull twice the amount of rope, and gravity is not in one's favor by pulling off.

The block and tackle uses one fixed and one movable pulley to reduce the amount of force needed to lift an object. However, many pulleys are incorporated into the block and tackle system. The trade off is that one has to pull however many times more rope to lift the object. The mechanical advantage decides how much rope would be needed to pull the object a certain distance and how much force is needed to move the object.

### SUMMARY OF THE DISCLOSURE

The disclosed hollow rung step ladder pulley hoist and tool retainer system includes a tubular insert having a first end configured to be received into an opening defined by a hollow rung in a side of an extension ladder and a second end configured with at least one pulley sheave wheel, a length of the tubular insert being less than or greater than a width of the rungs of the ladder. The system also includes a pulley cord of a length configured to run once around the at least one pulley sheave wheel and bear a load between a tension portion and a load portion. The system additionally includes a tool retainer configured to attach to the first end of the at least one tubular insert either proximal a received side of the ladder or proximal an opposite side of the ladder for a tubular insert length greater than a width of the rungs of the ladder. The system yet includes a holder configured to be received between the opening defined by a hollow rung in a side of an extension ladder and the tubular insert, the holder adapted to receive a tubular insert from both a left side and a right side of the ladder.

A method of hoisting something via the disclosure includes inserting a rod having a first end configured to be received into an opening defined by a hollow rung in a side of an extension ladder and a second end configured with at least one pulley sheave wheel, a length of the rod being less than or greater than a width of the rungs of the ladder. The method also includes running a pulley cord of a length configured to run once around the at least one pulley sheave wheel and bear a load between a pull portion and a load portion. The method further includes attaching a tool retainer to the first end of the rod either proximal a received side of the ladder or proximal an opposite side of the ladder for a rod length greater than a width of the rungs of the ladder

Other aspects and advantages of embodiments of the disclosure will become apparent from the following detailed description, taken in conjunction with the accompanying drawings, illustrated by way of example of the principles of the disclosure.

### BRIEF DESCRIPTION OF DRAWINGS

FIG. 1 depicts a perspective view of the ladder attached pulley hoist and tool retaining system according to an embodiment of the present disclosure.

FIG. 2 depicts a side perspective view of a conventional extension ladder showing the openings defined by hollow rungs in a side of the ladder.

FIG. 3 depicts a side perspective view of a holder of the hollow rung inserts in accordance with an embodiment of the present disclosure.

FIG. 4 depicts a side perspective view of a tool retainer chest or bucket in accordance with an embodiment of the present disclosure.

FIG. 5 depicts a side perspective view of a tool retainer rack in accordance with an embodiment of the present disclosure.

FIG. 6 depicts the drop-in stake stub detail in a drop-in position in accordance with an embodiment of the present disclosure.

FIG. 7 depicts a flow chart of a method for hoisting something via the ladder attached pulley hoist and tool retainer system in accordance with an embodiment of the present disclosure.

Throughout the description, same and similar reference numbers may be used to identify same and similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, the term ‘tubular insert,’ refers to a rod, bar, shaft, stick pole, strut, dowel, spoke, spike and cylindrical extension. The term ‘extension ladder,’ refers to a ladder having sides defining openings for hollow rungs and therefore may include ladders not limited to sliding extensions but also to fixed triangular ladders and non-conventional transforming ladders adapted with side openings for hollow rungs.

The ladder elevator is a pulley system. It attaches to a universal holder that goes in between the holes that are pre-made from factory on every extended ladder. This is done because all the steps of the ladder are hollow. I created what I call a holder that has a receiver where the pulley system attaches. There are two holders and two pulleys, one goes in the extended top part of the ladder and one goes on the base or bottom part of the ladder on the same side. Creating a rail or elevator this tool contains a bag where items can be stored. As you pull the rope the part can go up and down and will lock in position with a brake or ratchet on the pulleys. The elevator will extend as the ladder extends. Since the holder goes across the steps of the ladder, we can use various attachments for different purposes. For example, a rack for tools such as a hammer or drill, a small bucket or tray for nails and/or smaller hardware. The holder will have universal clips for the different attachments and can be used on either side (right or left). The elevator and attachments work in unison to make work in any field that involves extended ladders, safer and more efficient.

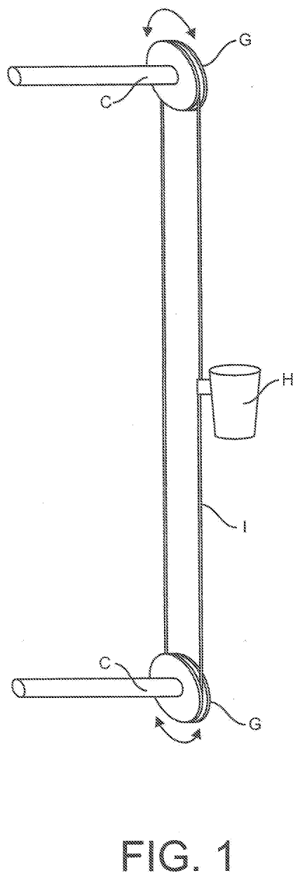

FIG. 1 depicts a perspective view of the ladder attached pulley hoist and tool retaining system according to an embodiment of the present disclosure. The depiction includes the tubular insert C, the pulley wheel G, the movable basket H and the pulley cord I. The loop of pulley cord I is according to an embodiment but other configurations including mulitple sheave wheels and multiple loops of cord for multiple mechanical advantage are also included and claimed herein.

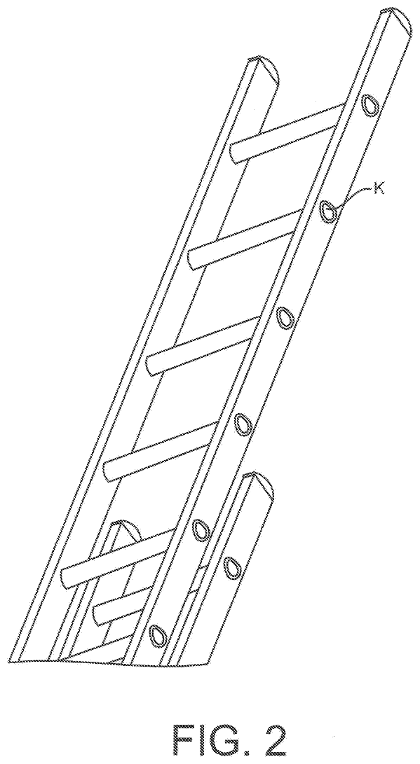

FIG. 2 depicts a side perspective view of a conventional extension ladder showing the openings defined by hollow rungs in a side of the ladder. The hollow rung opening K of the conventional extension ladder is defined in both sides of the ladder. Other ladders and other opening geometries are disclosed and claimed herein.

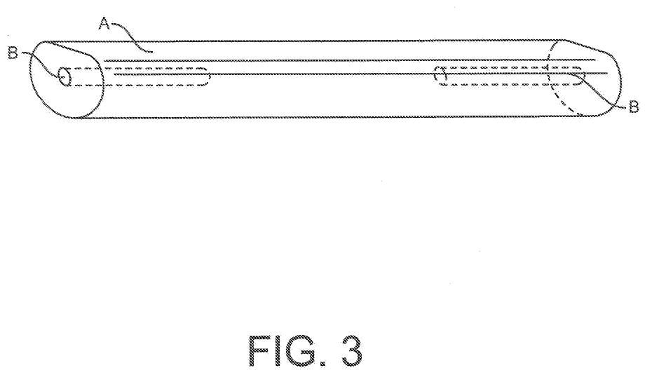

FIG. 3 depicts a side perspective view of a holder of the hollow rung inserts in accordance with an embodiment of the present disclosure. The depiction includes the holder insert A and a hole in the holder insert B. The holder insert is configured in a shape to fill the hollow rung opening defined in the ladder side. The holder insert may remain therein or be transient therein.

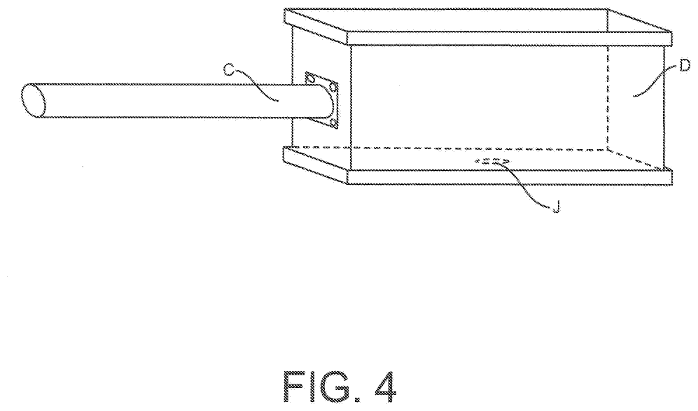

FIG. 4 depicts a side perspective view of a tool retainer chest or bucket in accordance with an embodiment of the present disclosure. The tubular insert C is long enough to extend all the way through a width of the ladder defined by its rungs. Therefore, the tool bucket D may be attached to a left side or to a right side proximal the ladder side according to a preference of the owner operator.

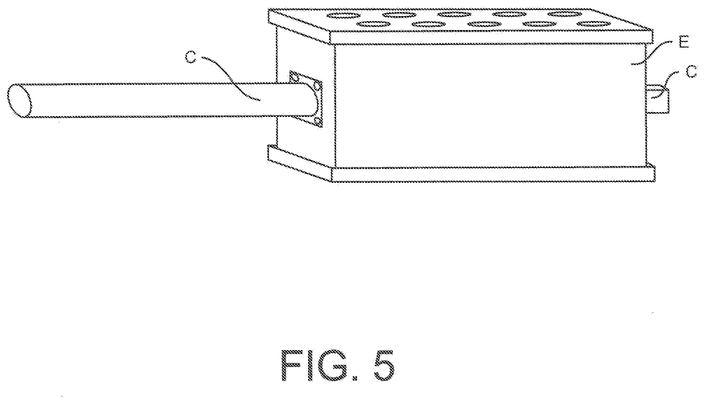

FIG. 5 depicts a side perspective view of a tool retainer rack in accordance with an embodiment of the present disclosure. The tubular insert C is shown detached from the pulley sheave wheel and attached to a tool rack top of a chest or retainer. The tool rack chest comprises multiple openings to receive multiple tools such as screw drivers, files, pliers and wrenches of conventional handle length.

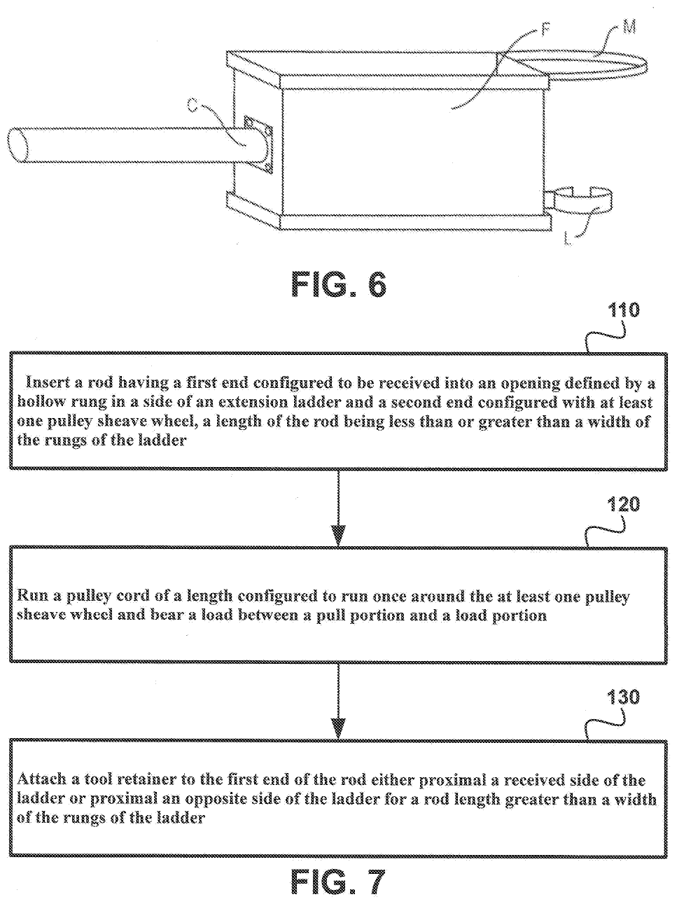

FIG. 6 depicts the drop-in stake stub detail in a drop-in position in accordance with an embodiment of the present disclosure. The tool helper F comprises loops used for retaining longer handle tools such as small shovels, pry bars etc. The tool helper F also comprises clips for holding tools. The tool helper body itself holds nails, rivets, screws and miscellaneous fasteners and tools.

FIG. 7 depicts a flow chart of a method for hoisting something via the ladder attached pulley hoist and tool retainer system in accordance with an embodiment of the present disclosure. The method of hoisting something via the disclosure includes inserting 110 a rod having a first end configured to be received into an opening defined by a hollow rung in a side of an extension ladder and a second end configured with at least one pulley sheave wheel, a length of the rod being less than or greater than a width of the rungs of the ladder. The method also includes running 120 a pulley cord of a length configured to run once around the at least one pulley sheave wheel and bear a load between a pull portion and a load portion. The method further includes attaching 130 a tool retainer to the first end of the rod either proximal a received side of the ladder or proximal an opposite side of the ladder for a rod length greater than a width of the rungs of the ladder

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A hollow rung step ladder apparatus:
a tubular insert having a first end configured to be received into an opening defined by a hollow rung in a side of an extension ladder and a second end configured with at least one pulley sheave wheel, a length of the tubular insert being less than or greater than a width of the rungs of the ladder;
a pulley cord of a length configured to run once around the at least one pulley sheave wheel and bear a load between a tension portion and a load portion; and
a tool retainer configured to attach to the first end of the at least one tubular insert either proximal a received side of the ladder or proximal an opposite side of the ladder for a tubular insert length greater than a width of the rungs of the ladder.

2. The apparatus of claim 1, further comprising a second tubular insert and a pulley cord length configured to run once around the first pulley sheave wheel and the second pulley sheave wheel and therebetween twice.

3. The apparatus of claim 1, wherein the tool retainer is a tool bucket configured to receive miscellaneous tools and hardware including nails and screws.

4. The apparatus of claim 1, wherein the tool retainer is a tool rack configured with a plurality of topside openings to receive short tools including screw drivers, nail sets and ratchet sockets.

5. The apparatus of claim 1, wherein the tool retainer is a tool helper configured with loops to receive long tools including hammers, pliers and saws.

6. The apparatus of claim 1, further comprising a bucket configured to attach to the pulley cord on the load portion of the pulley cord length.

7. The apparatus of claim 1, further comprising a holder configured to be received between the opening defined by a hollow rung in a side of an extension ladder and the tubular insert, the holder configured to remain inside the hollow rung opening.

8. The apparatus of claim 1, further comprising a holder configured to be received between the opening defined by a hollow rung in a side of an extension ladder and the tubular insert, the holder configured to have various outside diameters for various hollow rung openings and to have a constant inner diameter to receive the tubular insert.

9. The apparatus of claim 1, further an electric motor configured to turn the pulley sheave wheel.

10. The apparatus of claim 1, wherein the pulley cord length comprises a closed loop between a first pulley sheave wheel and a second pulley sheave wheel.

11. A hollow rung step ladder system, comprising:
a tubular insert having a first end configured to be received into an opening defined by a hollow rung in a side of an extension ladder and a second end configured with at least one pulley sheave wheel, a length of the tubular insert being less than or greater than a width of the rungs of the ladder;
a pulley cord of a length configured to run once around the at least one pulley sheave wheel and bear a load between a tension portion and a load portion;
a tool retainer configured to attach to the first end of the at least one tubular insert either proximal a received side of the ladder or proximal an opposite side of the ladder for a tubular insert length greater than a width of the rungs of the ladder; and
a holder configured to be received between the opening defined by a hollow rung in a side of an extension ladder and the tubular insert, the holder adapted to receive a tubular insert from both a left side and a right side of the ladder.

12. The system of claim 11, wherein the pulley sheave wheels further comprise ratcheting sheaves configured to prevent a backward motion of the pulley sheave.

13. The system of claim 11, further comprising a discrete pulley sheave wheel configured to provide a block and tackle mechanical advantage to hoisting a material or tools from ground level to a height of the tubular insert.

14. A method of hoisting something, the method comprising:
inserting a rod having a first end configured to be received into an opening defined by a hollow rung in a side of an extension ladder and a second end configured with at least one pulley sheave wheel, a length of the rod being less than or greater than a width of the rungs of the ladder;
running a pulley cord of a length configured to run once around the at least one pulley sheave wheel and bear a load between a pull portion and a load portion;
attaching a tool retainer to the first end of the rod either proximal a received side of the ladder or proximal an opposite side of the ladder for a rod length greater than a width of the rungs of the ladder.

15. The method of claim 14, further comprising receiving a holder between the opening defined by a hollow rung in a side of an extension ladder and the rod, the holder adapted to receive a rod from both a left side and a right side of the ladder.

16. The method of claim 14, further comprising inserting a first rod and pulley sheave wheel in a right side of a top rung and a second rod and pulley sheave wheel in a right side of a low rung and running a loop of pulley cord therebetween.

17. The method of claim 14, further comprising inserting a first pair of rod and pulley sheave wheels in a right side of the ladder and a second pair of rod and pulley sheave wheels in a left side of the ladder and running a first loop of pulley cord between the first pair and a second loop of pulley cord between the second pair.

18. The method of claim 14, further comprising hoisting a material or tools from ground level to a height of the rod via a discrete pulley sheave wheel configured to provide a block and tackle mechanical advantage including the rod and pulley sheave wheel.

19. The method of claim 14, further comprising hoisting and fixing a load on the pulley cord length via a ratcheting pulley sheave wheel configured to prevent a backward motion of the pulley cord length.

20. The method of claim 14, further comprising adjusting a length of the pulley cord to match a height of the extension ladder.
